(19) United States
(12) Patent Application Publication
(10) Pub. No.: US 2026/0089506 A1
(43) Pub. Date: Mar. 26, 2026

(54) DIGITAL IDENTITY MANAGEMENT

(71) Applicant: Lenovo (Singapore) Pte. Limited, Singapore (SG)

(72) Inventor: Sheeba Backia Mary Baskaran, Friedrichsdorf (DE)

(73) Assignee: Lenovo (Singapore) Pte. Limited, Singapore (SG)

(21) Appl. No.: 19/112,013

(22) PCT Filed: Sep. 18, 2023
(86) PCT No.: PCT/IB2023/059241

§ 371 Date: Mar. 14, 2025

Related U.S. Application Data
(60) Provisional application No. 63/408,627, filed on Sep. 21, 2022.
(60) Provisional application No. 63/408,639, filed on Sep. 21, 2022.
(60) Provisional application No. 63/408,645, filed on Sep. 21, 2022.

(51) Int. Cl. H04W 12/08

(52) U.S. Cl. CPC H04W 12/08

(57) ABSTRACT

Various aspects of the present disclosure relate to methods, apparatuses, and systems that support digital identity management. For instance, implementations provide permissioned distributed ledger (PDL) services and associated message exchanges and operations. Decentralized identifier (DID) document registry services, for example, are provided to enable management of DIDs, such as for actions including create/store, update, delete/revoke, etc., for DIDs. Further, verifiable credential (VC) data registry services are provided to enable management of VCs, such as for actions including create/store, update, delete/revoke, etc., for VCs.

### RELATED APPLICATIONS

This application claims priority to U.S. Provisional Application Ser. No. 63/408,627 filed 21 Sep. 2022 entitled “DIGITAL IDENTITY MANAGEMENT,” the disclosure of which is incorporated by reference herein in its entirety. This application also claims priority to U.S. Provisional Application Ser. No. 63/408,639 filed 21 Sep. 2022 entitled “REGISTRATION HANDLING OF LEDGER-BASED IDENTITY,” the disclosure of which is incorporated by reference herein in its entirety. This application also claims priority to U.S. Provisional Application Ser. No. 63/408,645 filed 21 Sep. 2022 entitled “DECENTRALIZED IDENTITY AUTHENTICATION AND AUTHORIZATION,” the disclosure of which is incorporated by reference herein in its entirety.

### TECHNICAL FIELD

The present disclosure relates to wireless communications, and more specifically to identity management.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for managing identities, such as for authentication and authorization purposes. Such systems, however, exhibit a number of drawbacks such as related to supporting digital identity (e.g., decentralized identities) and trust management processes.

### SUMMARY

The present disclosure relates to methods, apparatuses, and systems that support digital identity management. Implementations, for example, provide permissioned distributed ledger (PDL) services and associated message exchanges and operations. For instance, decentralized identifier (DID) document registry services are provided to enable management of DIDs, such as for actions including create/store, update, delete/revoke, etc., for DIDs. Further, verifiable credential (VC) data registry services are provided to enable management of VCs, such as for actions including create/store, update, delete/revoke, etc., for VCs.

By utilizing the described techniques, security of digital transactions (e.g., network-based transactions) is increased and system resources utilized to manage digital identities and digital transactions are conserved.

Some implementations of the methods and apparatuses described herein may further include receiving a storage request including a storage object and one or more of a source identifier, a registration identifier, service type information, access role, an authorization information, a decentralized identifier, or a request type; transmitting an authorization verification request for the storage request; receiving an authorization verification response based at least in part on the authorization verification request; transmitting, based at least in part on the authorization verification response, a registry notification including the storage object and one or more of registry service information, the request type, the source identifier, the service type information, the registration identifier, or authorization information; receiving, based at least in part on the registry notification, an acknowledgement message; and transmitting a storage response including an indication of a result of the storage request.

Some implementations of the methods and apparatuses described herein may further include: where the storage object includes one or more of a decentralized identifier, a decentralized identifier document, or a verifiable credential; the method is implemented as part of a ledger registration management service, further including receiving the storage request from one or more of an end-point device or an application; transmitting the authorization verification request to and receive the authorization verification response from a registry service; transmitting the registry notification to one or more of a permissioned distributed ledger node or a permissioned distributed ledger network; receiving the acknowledgement message from a registry service; and transmitting the storage response to one or more of the end-point device or the application; the registry notification further includes one or more of an identifier for the ledger registration management service, an authorized access role for the storage request, or a lifetime for the storage object; the registry service includes a decentralized identifier operation participant registry service.

Some implementations of the methods and apparatuses described herein may further include transmitting a registry notification transaction to the permissioned distributed ledger node, where the registry notification transaction includes one or more of a registry service type, a registry service identifier, a ledger registration management service identifier, the source identifier, the service type information, the registration identifier, an authorized access role, the authorization information, a lifetime for the storage object, a decentralized identifier, a decentralized identifier document, a verifiable credential, or request type information; the lifetime includes a lifetime for at least one of one or more decentralized identifier documents or one or more verifiable credentials; the storage request is associated with one or more of a decentralized identifier or a decentralized identifier document, and the storage response further includes one or more of a decentralized identifier resolver identifier, a decentralized identifier document registry address, a decentralized identifier document registry identifier, or a decentralized identifier resolver address; the request type includes one or more of a create indication, an update indication, or a delete indication; the authorization verification request includes one or more of the registration identifier, the source identifier, an access role for the storage request, or authorization information.

Some implementations of the methods and apparatuses described herein may further include: where the authorization information includes one or more of a code or a token; the authorization verification response includes one or more of the registration identifier, the source identifier, or a result indication for the authorization verification request; performing message to transaction adaptation to transform the registry notification into a registry notification transaction; the registry notification is related to one or more of a decentralized identifier document or a verifiable credential; the access role indicates whether the storage request is initiated by one or more of an identity holder, an identity controller, a decentralized identifier holder, a decentralized identifier controller, or a verifiable credential issuer; the indication of the result of the storage request includes an indication of a success of the storage request; the indication of the result of the storage request includes an indication of a failure of the storage request.

Some implementations of the methods and apparatuses described herein may further include receiving an authorization verification request for a storage request for a storage object, the authorization verification request including one or more of a registration identifier, a source identifier, an access role associated with the storage request, or an authorization code; processing the authorization verification request to determine whether the authorization verification request is valid; and transmitting an authorization verification response including an indication of a result of the authorization verification request and one or more of the registration identifier or the source identifier.

Some implementations of the methods and apparatuses described herein may further include: where the storage object includes one or more of a decentralized identifier, a decentralized identifier document, or a verifiable credential; the method is performed as part of a registry service, further including: receiving the authorization verification request from a ledger registration management service; and transmitting the authorization verification response to the ledger registration management service; the indication of the result of the authorization verification request includes one of an indication of a success of the authorization verification request or a failure of the authorization verification request.

Some implementations of the methods and apparatuses described herein may further include receiving a registry notification transaction, where the registry notification transaction includes a storage object and one or more of a registry service type, a registry service identifier, a ledger registration management service identifier, a source identifier, a service type information, a registration identifier, an authorized access role, authorization information, a lifetime for a storage object, a decentralized identifier, a decentralized identifier document, a verifiable credential, or request type information; recording the registry notification transaction; and transmitting an acknowledgement message including an indication of a result of the registry notification transaction and one or more of a registry service type, a registry service identifier, a storage object registry address, a storage object resolver identifier, or a storage object resolver address.

Some implementations of the methods and apparatuses described herein may further include: where the storage object includes one or more of a decentralized identifier, a decentralized identifier document, or a verifiable credential; the method is performed as part of a storage object registry service, further including receiving the registry notification transaction from a permissioned distributed ledger node; and transmitting the acknowledgement message to a ledger registration management service; the indication of the result of the registry notification transaction includes one of an indication of a success of the registry notification transaction or a failure of the registry notification transaction.

Some implementations of the methods and apparatuses described herein may further include transmitting a decentralized identifier resolver transaction notification including a decentralized identifier and one or more of a request type, a decentralized identifier registry address, a decentralized identifier resolver identifier, or a decentralized identifier resolver address; and receiving an acknowledgement message including a result of the decentralized identifier resolver transaction notification and one or more of a ledger registration management service identifier, the decentralized identifier, the decentralized identifier resolver identifier, a decentralized identifier document registry address, a decentralized identifier document registry identifier, or the decentralized identifier resolver address.

Some implementations of the methods and apparatuses described herein may further include: where the result of the decentralized identifier resolver transaction notification includes one of an indication of a success of the decentralized identifier resolver transaction notification or a failure of the decentralized identifier resolver transaction notification.

Some implementations of the methods and apparatuses described herein may further include receiving a decentralized identifier resolver transaction notification including a decentralized identifier and one or more of a decentralized identifier registry address, a decentralized identifier resolver identifier, or a decentralized identifier resolver address; storing at least some information included in the decentralized identifier resolver transaction notification; and transmitting an acknowledgement message including a and one or more of a ledger registration management service identifier, the decentralized identifier, the decentralized identifier resolver identifier, a decentralized identifier document registry address, a decentralized identifier document registry identifier, or the decentralized identifier resolver address.

Some implementations of the methods and apparatuses described herein may further include: where the result of the decentralized identifier resolver transaction notification includes one of an indication of a success of the decentralized identifier resolver transaction notification or a failure of the decentralized identifier resolver transaction notification.

### BRIEF DESCRIPTION OF THE DRAWINGS

FIG. 1 illustrates an example of a wireless communications system that supports digital identity management in accordance with aspects of the present disclosure.

FIG. 2 illustrates an example of verifiable claim(s) generation and use.

FIG. 3 illustrates an example of DID registry on distributed ledger and blockchain such as related to registration handling of ledger-based identity in accordance with aspects of the present disclosure.

FIG. 4 illustrates a system presenting an example architecture for identity management and identity verification in the perspective of Self-sovereign Identities (SSI).

FIG. 5 illustrates a PDL platform that supports digital identity management in accordance with aspects of the present disclosure.

FIG. 6 illustrates portions of a system that support digital identity management in accordance with aspects of the present disclosure.

FIG. 7 illustrates portions of a system that support digital identity management in accordance with aspects of the present disclosure.

FIG. 8 illustrates a system that supports digital identity management in accordance with aspects of the present disclosure.

FIG. 9 illustrates an example of a block diagram of a device that supports digital identity management in accordance with aspects of the present disclosure.

FIGS. 10 through 14 illustrate flowcharts of methods that support digital identity management in accordance with aspects of the present disclosure.

### DETAILED DESCRIPTION

In some identity systems, digital identity management related to DIDs and SSIs involves various processes such as storage, management, handling, verification of identities and relevant documents (e.g., VCs, cryptography related information, etc.), and selective data disclosure in a distributed platform (e.g., PDLs) to enable digital identity-based authentication and authorization. Further, such processes may involve multiple actors such as an identity holder (e.g., DID holder), a DID controller, a VC issuer, a relying party (e.g., verifier), etc. Some existing platforms, however, do not offer services to support digital identity-specific identity and trust management processes which involve storage, management, handling, verification, and management of multiple actors (e.g., access control and authorization), selective data disclosure to relying parties, and so forth.

Accordingly, this disclosure provides for techniques that support digital identity management. For instance, implementations provide methods, apparatuses, and systems that support digital identity management. For instance, implementations provide permissioned distributed ledger (PDL) services and associated message exchanges and operations. For instance, DID document registry services are provided to enable management of DIDs, such as for actions including create/store, update, delete/revoke, etc., for DIDs. Further, verifiable credential (VC) data registry services are provided to enable management of VCs, such as for actions including create/store, update, delete/revoke, etc., for VCs.

Implementations described herein, for instance, provide for storage and management of DID associated DID Documents and Verifiable credentials in a ledger, including:
Storage of DID and DID Documents (e.g., on request from a DID holder and/or DID controller)
Update of DID and DID Documents (e.g., on request from a DID holder and/or DID controller)
Delete/Revoke DID and DID Documents (e.g., on request from a DID holder, DID controller, and/or ledger-registration management service (L-RMS) in a PDL platform)
Storage of VC (e.g., on request from a DID holder, DID controller, and/or VC issuer)
Update of VC (e.g., on request from a DID holder, DID controller, and/or VC issuer)
Delete/Revoke VC (e.g., on request from a DID holder, DID controller, and/or VC Issuer)

Accordingly, by utilizing the described techniques, security of digital transactions (e.g., network-based transactions) is increased and system resources utilized to manage digital identities and digital transactions are conserved.

Aspects of the present disclosure are described in the context of a wireless communications system. Aspects of the present disclosure are further illustrated and described with reference to device diagrams and flowcharts.

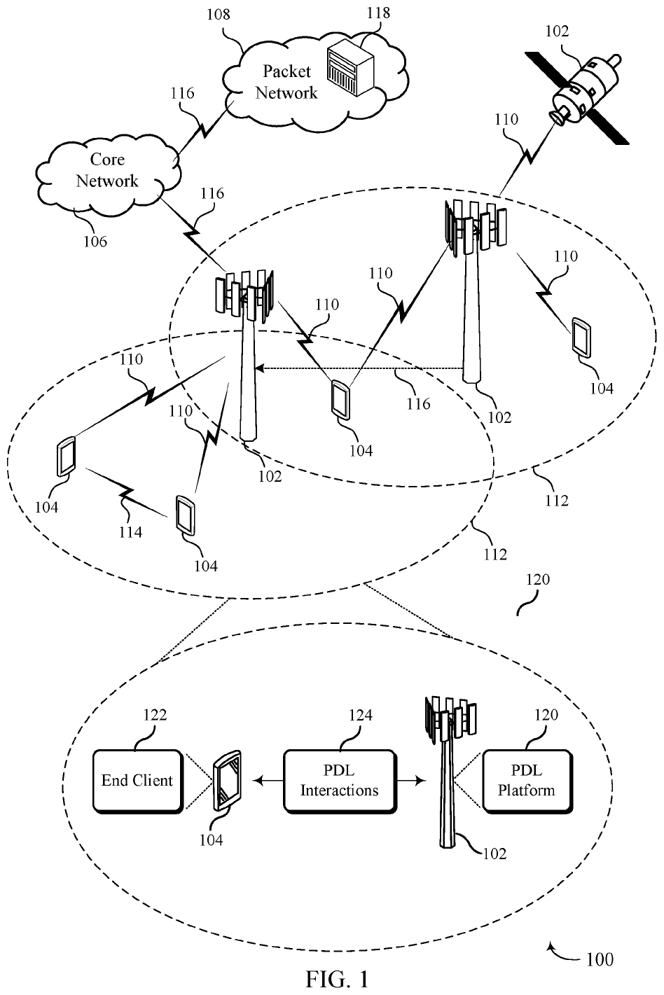

FIG. 1 illustrates an example of a wireless communications system 100 that supports digital identity management in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, media access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a PDU session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for digital identity management, a network entity 102 can implement at least a portion of a PDL platform 120 and a UE 104 can represent an instance of an end client 122, e.g., an endpoint client device and/or application. Example implementation details of the PDL platform 120 and the end client 122 are discussed below in detail. Accordingly, the network entity 102 and the UE 104 can interact as part of PDL interactions 124, such as part of management of various aspects of DIDs, DID documents, VCs, and so forth. As further detailed below, for example, the PDL platform 120 can provide various services pertaining to DIDs, DID documents, and VCs for the end client 122.

In some networking scenarios, decentralized identity and/or Self-Sovereign Identity (SSI)-based identity management solutions are discussed in the context of a trust framework. For instance, Decentralized Identifiers (DIDs) are a type of identifier for verifiable, “self-sovereign” digital identity. DIDs can be fully under the control of a DID subject and independent from a centralized registry, identity provider, or certificate authority. DIDs can be URLs that relate a DID subject to a means for trustable interactions with that subject. DIDs can resolve to DID Documents, e.g., simple documents that describe how to use that specific DID. Each DID Document may contain at least three things: proof purposes, verification methods, and service endpoints. Proof purposes can be combined with verification methods to provide mechanisms for proving things. For example, a DID Document can specify that a particular verification method, such as a cryptographic public key or pseudonymous biometric protocol, can be used to verify a proof that was created for the purpose of authentication. Service endpoints can enable trusted interactions with the DID controller.

As DIDs may be implemented as an identifier, they may not provide information about the subject itself. In practice, DIDs are used in combination with Verifiable Claims to support digital interactions in which information about the subject is to be shared with third parties, such as by proving to those third parties that the DID subject has ownership of certain attestations or attributes. This proof can be based on a cryptographic link between the Verifiable Claims, the DID subject that the Verifiable Claims is about, and the issuer of the Verifiable Claims, which can be the DID subject (e.g., for self-asserted claims) or a trusted entity. Trust on the issuer can be established either by trusting the issuer's DID (e.g., out-of-band, bilateral relationship, trusted lists) or by any other means. A third party can then use the presented cryptographically protected proof to verify the ownership and trustworthiness of the claims about the subject. As the presentation of the claims is managed by the users, the users can decide on which specific pieces of information about themselves they want to share with third parties; by means of this selective disclosure of attributes privacy and personal data protection is reinforced.

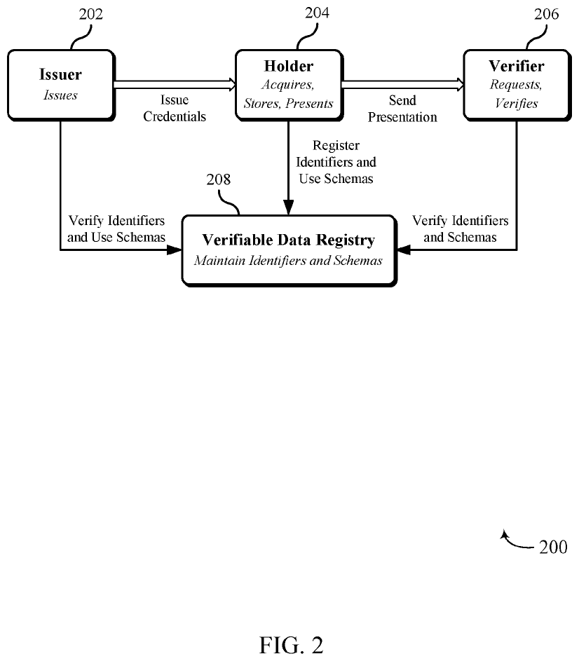

FIG. 2 illustrates an example 200 of verifiable claim(s) generation and use. The example 200, for instance, is related to identity authentication and verification, such as pertaining to registration handling of ledger-based identity in accordance with aspects of the present disclosure. The flow of information of the verifiable claims generation and use, as shown in the example 200, is derived from the W3C working draft of the verifiable credentials data model (1.0). In this data model, credentials are considered as a set of one or more claims made by an issuer 202 and may also include credential metadata and one or more proofs. In this example 200, the issuer 202 issues credentials to a holder 204 that acquires, stores, and presents the credentials. The holder 204 sends a presentation to a verifier 206 that requests and verifies. A verifiable data registry 208 receives input from the issuer 202, from the holder 204, and from the verifier 206, and the verifiable data registry 208 maintains identifiers and schemas.

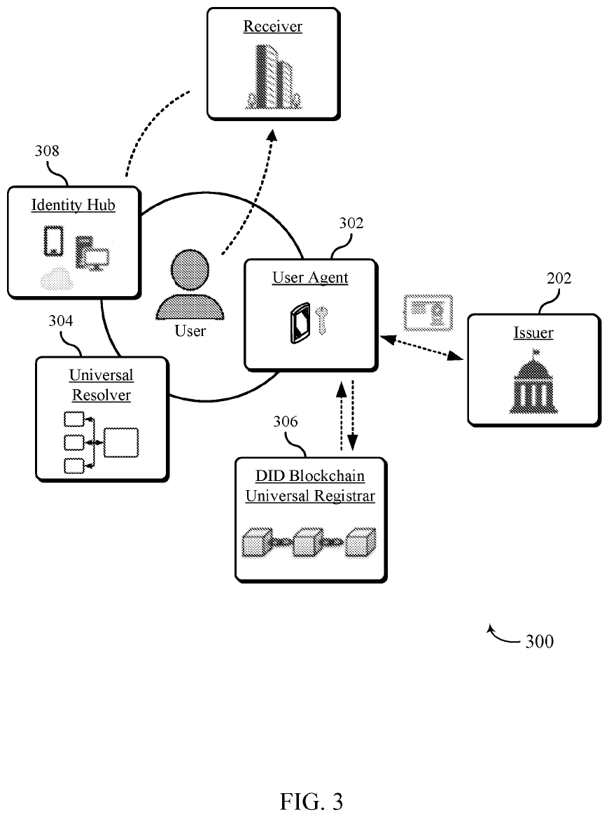

FIG. 3 illustrates an example 300 of DID registry on distributed ledger and blockchain such as related to registration handling of ledger-based identity in accordance with aspects of the present disclosure. To implement DID and VC, organizations working on SSI rely on the use of distributed ledgers and/or blockchains to support the registry of identifiers. In particular, the Decentralized Identity Foundation (DIF) proposes the architecture shown in the example 300, which includes several components. For example, a user agent 302 is a program, such as a browser, mobile application, or other web-based client, that mediates the communication between holders (204), issuers (202), and verifiers (206). A universal resolver 304 is a server featuring a pluggable system of DID method drivers that enables resolution and discovery of DIDs across any decentralized system. A universal registrar 306 is a server that enables the registration of DIDs across any decentralized system that produces a compatible driver. Additionally, an identity hub 308 is a secure personal datastore that coordinates storage of signed and/or encrypted data, and relays messages to identity-linked devices.

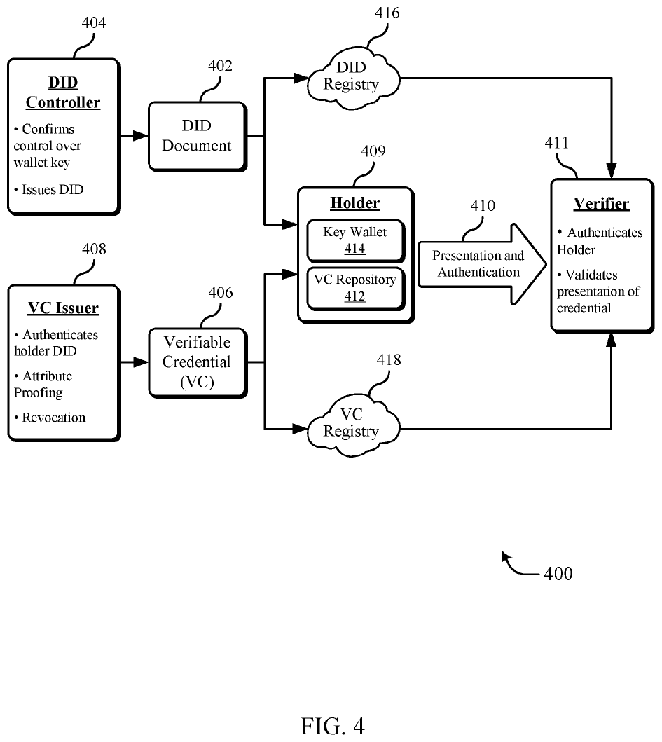

FIG. 4 illustrates a system 400 presenting an example architecture for identity management and identity verification in the perspective of SSI. The system 400, for example, includes the following architectural elements:
DID: A type of identifier that enables verifiable, decentralized digital identity. A DID can refer to any subject (e.g., a person, organization, thing, data model, abstract entity, etc.) as determined by a controller of the DID. A DID may be considered as a form of pseudonym as it may not directly linked to a formal identifier of a natural or legal person.
DID Document 402: DID documents contain information associated with a DID. They typically express verification methods, such as cryptographic public keys, and services relevant to interactions with the holder. A DID document may be signed by a DID Controller.
DID Controller 404: The controller of a DID is the entity (e.g., person, organization, autonomous software, etc.) that has the capability-as defined by a DID method—to make changes to a DID document. The following secure processes for the DID controller can be utilized:
   Proof of possession or control of the holder of its private key
   Issuance of a unique DID to the holder
VC 406: A set of one or more claims made by an issuer. A verifiable credential is a tamper-evident credential that has authorship that can be cryptographically verified.
VC Issuer 408: A role an entity can perform by asserting claims about one or more subjects, creating a verifiable credential from these claims, and transmitting the verifiable credential to a holder 409. The following secure processes are for the DID controller can be utilized:
   Authentication of the holder as identified by its DID
   Proofing that the claimed attributes belong to the holder
   Revocation of a holder's attributes
Presentation 410: Data derived from one or more verifiable credentials, issued by one or more issuers, that is shared with a specific verifier 411. A verifiable presentation is a tamper evident presentation encoded in such a way that authorship of the data can be trusted after a process of cryptographic verification.
Repository 412: A program, such as a storage vault or personal verifiable credential wallet, that stores and protects access to holders' verifiable credentials. The use of the repository can be restricted to the holder or other authorized parties.
Key Wallet 414: Application used to generate, manage, store or use private and public keys. A Key Wallet may be protected by specially protected “secure element” within the Wallet. The use of the keys can be restricted to the holder.
Wallet: A Wallet can be used to cover the repository of verifiable data (DID documents, verifiable credentials) and a Key Wallet. A Wallet may be considered as a form of Secure Area (SA-Application). For instance, this may be supported through use of an agent service that is remotely accessed from the user's device and controlled through use of multiple authentication factors.
DID Registry 416: In order to be resolvable to DID documents, DIDs can be recorded on an underlying system or network of some kind. Regardless of the specific technology used, any such system may be used that supports recording DIDs and returning data necessary to produce DID documents. This can be referred to as the DID document registry. The DID registry can be based on a distributed ledger such as blockchain.
VC Registry 418: A role a system may perform by mediating the creation and verification of identifiers, keys, and other relevant data, such as verifiable credential schemas, revocation registries, issuer public keys, and so on, which might be specified to use verifiable credentials. Some configurations might use correlate identifiers for subjects. Some registries, such as ones for UUIDs and public keys, might act as namespaces for identifiers.
Holder Authentication: A protocol exchange to obtain authorized access to a resource.

In an example implementation, the European Telecommunications Standards Institute (ETSI) PDL reference architecture describes services such as registration services, identity services and identity management services (among other services) as described below.

Registration: List a managed object with authorities or registries according to Clause 5.4.2.5 ETSI-ISG-PDL Registration Platform Service. Registration services can provide means to list an ETSI-ISG-PDL Managed Object with local or international authorities or registries. Such registries allow reference to such Managed Objects for legal, commercial and Operational purposes. Registration requirements may vary with geography, though not all registries are linked to the geography in which they are used. Certain Managed Objects (e.g. a PDL serving a geographically diverse application) operate in multiple geographies and may require multiple registrations. An ETSI-ISG-PDL Managed Object MAY be registered in one or more registries. A registered ETSI-ISG-PDL Managed Object is to be registered in accordance with the regulations and rules applicable in the geographies in which it operates.

Application Registration: Registers and lists all applications operated on a platform. According to Clause 5.4.3.21.6 Application Registration, Application registration is a functionality that registers and lists all applications operated on a platform. An ETSI-ISG-PDL platform is to maintain a list of all applications registered and operated on it.

Identity: Unambiguously identifies an instance of an entity from other instances of this and other objects. According to clause 5.4.2.3 ETSI-ISG-PDL Identity Platform Service the Identity of an entity is a set of context-dependent digital identifiers that unambiguously identify an instance of that entity from all other instances of this and other objects. An identity may use multiple attributes to uniquely identify it (e.g. two products with the same name have other different attributes, such as different serial numbers).

An ETSI-ISG-PDL Identity is to be constructed using one or more context-dependent digital identifiers that enable an object instance to be unambiguously identified. A digital identifier is a secure object that is unique within a particular namespace. It is recommended that every digital identifier is assigned a namespace. An ETSI-ISG-PDL digital identifier can be defined within a namespace to guarantee its uniqueness. An entity may be used in different situations. Therefore, the same entity may be identified using a different set of digital identifiers for each situation. This enables the semantics of the use of an entity in each situation to be taken into account.

An ETSI-ISG-PDL Managed Object may have multiple context-dependent digital identifiers for establishing the Identity of that Managed Object in different situations in which it is used. An ETSI-ISG-PDL Identity Service provides a single identity token per instance of an entity for all services so that this instance is identified unambiguously and in the same manner by all services. An ETSI-ISG-PDL Identity Service is to provide a single digital identity token per instance of an entity.

Identity Management: Access control based on the identity of an entity. According to clause 5.4.3.4.6 ETSI-ISG-PDL Identity Management Platform Service Identity Management defines access control based on the identity of an entity that initiates a particular set of operations on a target according to a set of criteria. The ETSI-ISG-PDL Identity Management Platform Service depends on the ETSI-ISG-PDL Namespace Platform Service and the ETSI-ISG-PDL Identity Platform Service.

An Identity-Management Platform Service is to be implemented in all ETSI-ISG-PDL compliant platforms. The Identity Management Platform Service and the Identity Platform Service can be two distinct and different services. The Identity Platform service defines how identities are assigned, while the Identity Management Platform Service defines how access is managed based on an assigned identity.

Thus, implementations have been described pertaining to registration, application registration, identity, and identity management. Such implementations, however, exhibit drawbacks in terms of supporting the decentralized identity management and related verification processes as shown by the following limitations.
(i) Registration service and application registration service do not support role-based access control and authorization setting as part of registration which can be very important to handle different parties and their operations for a decentralized identity and trust management framework.
(ii) The identity and identity management service does not enable an identity holder (e.g., an end-device and/or application) to set an identifier for itself or allow the identity holder (e.g., as an identity controller) to set an identifier for another device and/or object associated to it.
(iii) The existing PDL services do not support selective data sharing specific to managed identifier(s).

Accordingly, solutions are provided in this disclosure that support digital identity management, such as for PDL platform services to support identity (e.g., DID and SSI based) and trust management solutions which utilize a PDL and/or other ledger platform. For instance, the described solutions provide a DID Document Registry service (e.g., for Create/store, Update, Delete/Revoke, etc. and a VC Data Registry service, e.g., for Create/store, Update, Delete/Revoke, etc.

In implementations, techniques for managing (e.g., storing, updating, deleting, and revoking) DID and DID documents are described, such as in a PDL platform. DIDs, for instance, resolve to DID Documents, which represent documents that describe how to use a specific DID. Each DID Document may contain at least three things: proof purposes, verification methods, and service endpoints. Proof purposes can be combined with verification methods to provide mechanisms for proving things. For example, a DID Document can specify that a particular verification method, such as a cryptographic public key or pseudonymous biometric protocol, can be used to verify a proof that was created for the purpose of authentication. Service endpoints enable trusted interactions with a DID controller. Further the management of DID and related DID documents can involve operations such as:
1. Storage of DID and DID Documents, e.g., on request from a DID holder or DID controller;
2. Update of DID and DID Documents, e.g., on request from the DID holder or DID controller;
3. Delete/Revoke DID and DID Documents, e.g., on request from the DID holder, DID controller, and/or L-RMS in a PDL platform.

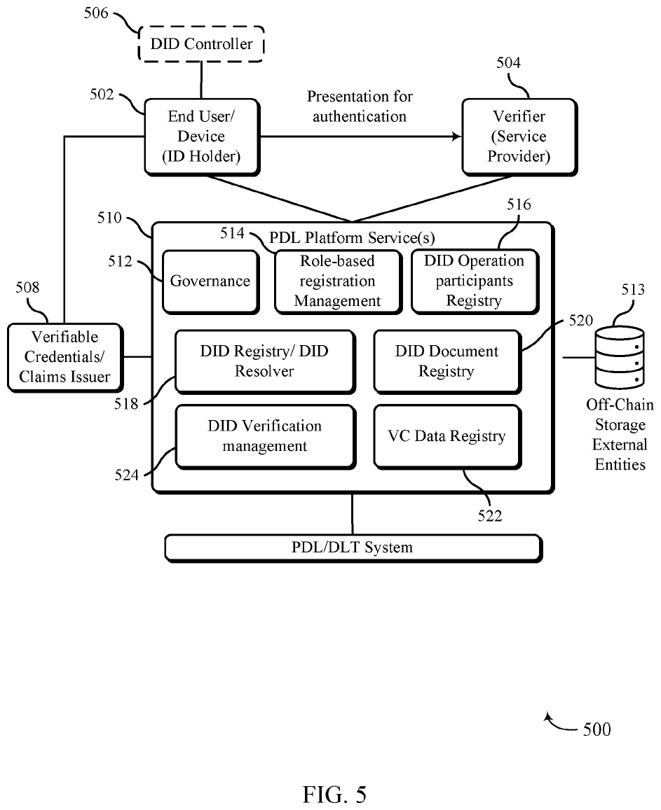

FIG. 5 illustrates a PDL platform 500 that supports digital identity management in accordance with aspects of the present disclosure. In the platform 500, an identity holder 502 (e.g., can be referred as the subject, such as a person, organization, thing, data model, abstract entity, function, end-user, device, etc.) can generate a digital identifier, e.g., a DID and/or SSI. The identity holder 502, for instance, can itself generate the digital identifier and/or the digital identifier can be generated and provisioned to the identity holder 502 by a service provider 504 or a DID controller 506, e.g., another party which creates the digital identifier on behalf of the identity holder to identify and authenticate the identity holder. Some examples of the DID controller 506 include, (i) an organization that can be an identity controller for its employees who are the identity holders, (ii) a person that can be the identity controller for the IoT object associated to the person, where the IoT object can be the identity holder, etc.

A verifiable credentials/claims issuer 508 (VC Issuer) can perform asserting claims about one or more subjects, creating a verifiable credentials (VCs) from these claims (e.g., passport, driving license, and birth certificate), and transmitting the verifiable credential to a holder. A VC, for instance, includes a set of one or more claims made by an issuer. A VC, for instance, represents a tamper-evident credential that has authorship that can be cryptographically verified. The identity holder 502 presents the data (e.g., for authentication and authorization) derived from one or more verifiable credentials, issued by one or more issuers, which is shared with a specific verifier. A verifiable presentation is a tamper evident presentation encoded in such a way that authorship of the data can be trusted after a process of cryptographic verification.

To enable a verifier (such as a service provider and/or 3^{rd} party service provider) to verify a DID and authenticate an identity holder/subject, the platform 500 includes PDL services 510 in addition to existing PDL services related to role-based registration, storage and management of DIDs, DID documents, VCs, verification of DIDs and selected exposure of data and/or claims (e.g., as utilized by the services), etc. Further the DID-based identity framework may also include services related to governance (e.g., Governance Platform Services 512 can be a collection of rules and tools that control the behaviour and function of a PDL Platform to enable identity and trust management) and off-chain storage 513 (e.g., storing of information in a digital, machine-readable medium that is not stored on the main chain) to enable scaling of blockchain-based applications that are data-intensive and/or data sensitive such as VCs. The DID-based identity framework, for instance, may be used to store non-transactional data that is too large to be stored in the blockchain efficiently, and/or that requires the ability to be changed or deleted. Off-Chain data may be accessible by a subset of the nodes participating in a chain.

Role-based registration management service 514, e.g., with operations involving registration, revoke, de-registration, etc: The role-based registration management service 514 may consider the following different roles, actors, and/or participants to be involved in the identity and trust management framework, and can provide registration service (along with authorization) specific to the corresponding roles of the actor in the PDL platform.
Identity Holder;
Identity Controller;
VC Issuer;
Identity Verifier; and
Others (e.g., any participant/stakeholder to be involved in the identity and trust management framework).

DID Operation participants Registry service 516: The DID Operation(al) participants registry service 516 can record and keep track of the registered and de-registered identity and trust management framework participants in the PDL platform 500 based on instructions from the Role based registration management service 514.

DID Registry/DID Resolver service 518: The DID Registry/DID Resolver service 518 can store and keep track of the DID(s) and its associated DID document location information (e.g., address) to enable DID document fetching and verification by the authorized services and entities.

DID Document Registry service 520, which operations may involve Create/store, Update, Delete/Revoke, etc., for DID documents: The DID Document Registry service 520 can store and manage the DID documents associated to the DID to facilitate DID verification. Each DID Document may contain at least three things: proof purposes, service specific information for which the DID document can be used, verification methods, and service endpoints. Proof purposes can be combined with verification methods to provide mechanisms for proving things. For example, a DID Document can specify that a particular verification method, such as a cryptographic public key or pseudonymous biometric protocol, can be used to verify a proof that was created for the purpose of authentication. Service endpoints enable trusted interactions with the DID controller as well as authorized verifier.

Verifiable credentials (VC) Data Registry service 522, which operation may involve Create/store, Update, Delete/Revoke VCs: The VC Registry service 522 can store and manage the VCs associated to the DID to facilitate VC based DID verification and validation related to service request.

DID Verification service 524: The DID verification service 524 may be a composite service that uses DID registry service/DID resolver service 518, DID document registry service 520 and DID operation(al) participant registry service 516 to fetch necessary data related to verification of DID (e.g., authentication of the subject identified by the DID), and exposure of selective data to the verifier to enable authorization verification of subject to respective service(s).

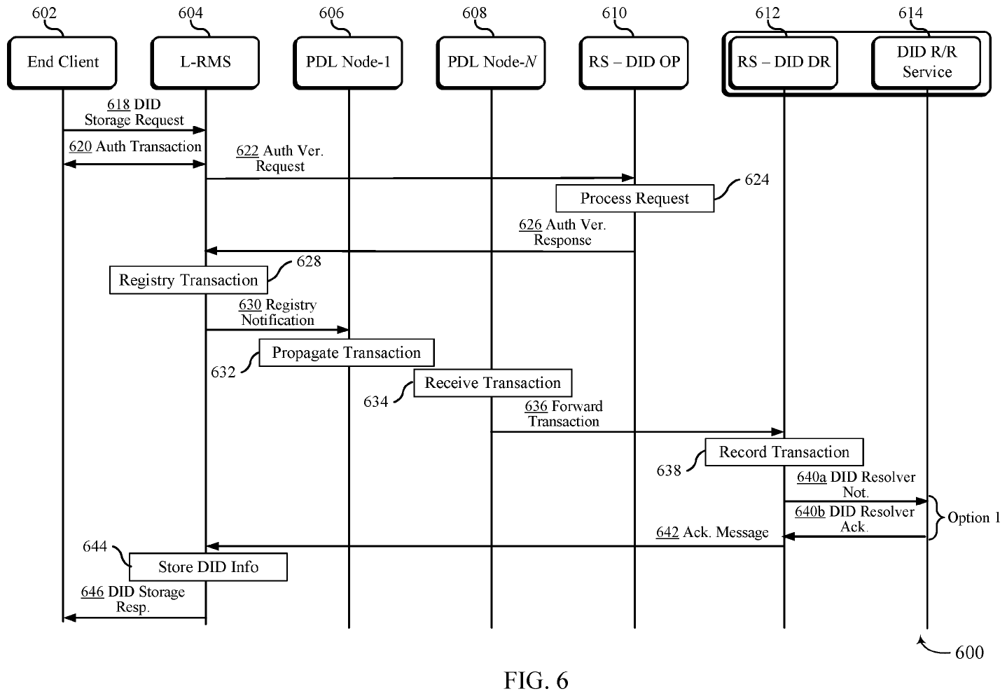

FIG. 6 illustrates portions of a system 600 that support digital identity management in accordance with aspects of the present disclosure. The system 600, for example, can be implemented to store DID and DID Documents in the PDL platform 500 introduced above. The system 600 includes an end client 602 (e.g., an endpoint device and/or application), a PDL platform L-RMS 604, a PDL node 608 (e.g., which belongs a PDL network) 606, a PDL node (e.g., which belongs a PDL network), a registry service DID operation participants registry (RS-DID OP) 610, a registry service DID document registry (RS-DID DR) 612, and a DID registry/resolver service (DID R/R service) 614.

In an example operation of the system 600 at 618 the end client 602 can send to the L-RMS 604 a DID document storage request 618 which can include various information such as Source Identity (e.g., a PDL user identifier (ID)), Registration ID, service type information (e.g., which may indicate a DID service), access role (e.g., indicated as ID/DID holder, which can be the subject and/or end-user), authorization information (e.g., a code or token received as authorization information during a successful registration), DID document(s), a request type (e.g., set as store/create), etc. The DID document(s) can include information such as the DID, DID controller ID, verification method(s), cryptographic public key, service type/info, other info, verifiable claims, uniform resource indicator (URI) related to claims, etc. In implementations, if a secure connection exists, the end client 602 (e.g., ID holder) can send the document storage request at 618. Else the end client 602 and the L-RMS 604 at 620 can perform mutual authentication and set up a secure connection before implementing the DID document storage request 618.

In an alternative or additional implementation, the end client 602 can send the DID document storage request 618 to the L-RMS 604 with information except a registration ID, access role, DID documents and the authorization code. Accordingly, at 620 the L-RMS 604 can transmit a request for this information by sending an authorization request message with source ID to the end client 602. The end client 602 at 620 can then respond with an authorization response message with Registration ID, access role, DID documents, and authorization information.

At 622 the L-RMS 604 sends to the RS-DID OP 610 (e.g., as related to the DID Operation(al) participants and/or alternatively termed as Identity and Trust management framework/platform participants) and based on the local configuration and policies, an authorization verification request message 622, which can include Registration ID, Source ID, Access role and authorization information (e.g., code and/or token for authorization).

At 624 the RS-DID OP 610 processes the authorization verification request message 622 to verify the authorization information (e.g., authorization code or token) related to the Registration ID and the access role. The RS-DID OP 610, for instance, queries a respective ledger and/or chain (e.g., for a related transaction history and/or records) and/or checks an offline and/or local storage to check if the authorization information and registration ID matches with a record related to the registered participant. The RS-DID OP 610 can also check if the access role of the participant is correct based on the records.

At 626, if the verification of the registration ID, access role and authorization information are successful at the RS-DID OP 610, the RS-DID OP 610 sends to the L-RMS 604 an authorization verification response message 626 which can include the registration ID, source ID and result as ‘successful’. Alternatively, if the verification of the registration ID, access role and authorization information at 624 do not match with a record and/or if the registered access role is different from the one received at 622, the RS-DID OP 610 can send to the L-RMS 604 the authorization verification response message 626 which can include the registration ID, source ID, and a result as ‘failure’.

At 628, if the L-RMS 604 determines based on the authorization verification response message 626 that the authorization verification is successful, the L-RMS 604 performs a registry transaction process to generate a DID document registry notification message 630 which can include information such as the target Registry service type and/or ID, Create Indication*, L-RMS ID, Source Identity, Service type information (DID service), Registration ID, authorized access role, Authorization code, Lifetime, DID, and DID Document(s). Further the document registry notification message 630 can be transformed into a DID document transaction to store the DID documents to the corresponding registry (e.g., a DID document registry) indicated by a target Registry service type/ID.

In an Alternative implementation, the L-RMS 604 can directly generate the DID Document transaction which can include the DID document registry notification message (target Registry service type/ID, request type (e.g., with store/Create Indication)*, L-RMS ID, Source Identity, Service type information (DID service), Registration ID, authorized access role, Authorization code, Lifetime, DID, DID Document(s), etc.

Alternatively, if a failure is indicated at 626, then the process can proceed to 646 to indicate to the end client 602 that the failure occurred.

The L-RMS 604 can send the document registry notification message 630 which includes the DID document transaction to the configured PDL node 606. At 632 the PDL node 606 propagates the received DID document transaction from the document registry notification message 630 through the system 600. At 634 the PDL node 608 (e.g., a PDL Node-2) receives the DID document transaction from the target PDL network as the result of transaction propagation at 632.

After the DID document transaction is validated and is successfully stored to the ledger (e.g., as a result of a PDL consensus process in a ledger related to the registry service associated to the DID Document (transaction) based on the target registry service type information), at 636 the PDL node 608 forwards the DID document transaction to the RS-DID DR 612 based on target registry service information. The RS-DID DR 612 can transform the transaction into a message to recover the message, e.g., the DID document registry transaction as a DID document registry notification message. Alternatively, the PDL node 608 transforms the transaction into a message and sends the DID document transaction as a DID document registry notification message to the RS-DID DR 612. At 638 the RS-DID DR 612 may store the DID document transaction and/or information received at 636 as part of the DID document registry notification message (or vice versa) in a local storage, off-chain, and/or as part of a ledger.

At 640a the RS-DID DR 612 may send to the DID R/R service 614 a notification message 640a (e.g., a DID resolver notification message) which can include DID, request type (e.g., Create/store Indication)*, and DID Document Registry ID/address. The notification message 640a can be alternatively termed as a “DID registry notification message.” At 640b the DID R/R service 614 records and stores the DID and the DID Document Registry ID/address and sends to the RS-DID DR 612 a DID resolver acknowledgement (Ack) message 640b which can include DID and a success indication.

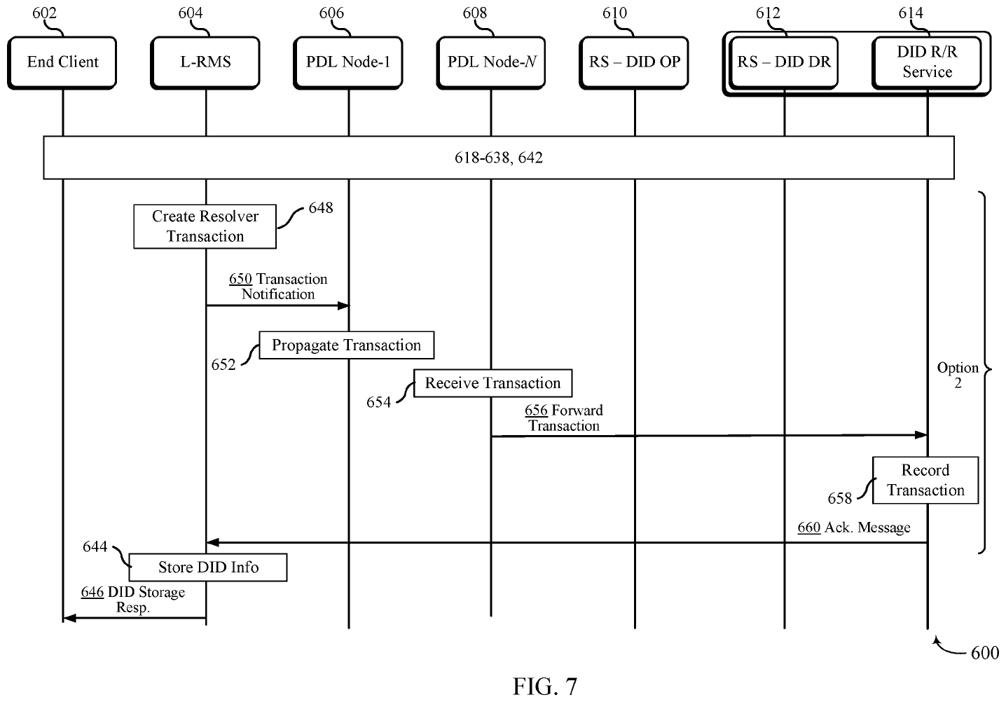

At 642 the RS-DID DR 612 may send to the L-RMS 604 an acknowledgement message 642 which can include the L-RMS ID (e.g., as received at 636 as part of the transaction message related to the DID document registry notification), Source Identity, Registry service type, registry service ID, DID Document Registry address, result indication (e.g., success or failure), DID resolver registry service ID, DID resolver registry service address*, etc. In implementations, 640a, 640b, and 642 are part of an Option 1 for storage of DID and DID Documents. A second option is described below in FIG. 7.

At 644 the L-RMS 604 can store the DID, resolved ID and/or address locally and/or in off-chain. At 646 the L-RMS 604 sends to the end client 602 a DID document storage response message 646 which can include the DID resolver ID, address, and result indication. The result indication, for instance, indicates a success or failure that occurred as part of the DID storage request 618.

FIG. 7 illustrates portions of the system 600 that support digital identity management in accordance with aspects of the present disclosure. This implementation of the system 600, for example, represents an alternative or additional implementation to that discussed above with reference to FIG. 6, such as an alternative to using 640a, 640b described above. For instance, the actions at 618-638, 642 are performed such as described above. Further, where 640a, 640b are not implemented, a DID resolver ID and/or address may be provided.

Accordingly, at 648 the L-RMS 604 creates a DID resolver transaction notification message 648 which can include the DID, DID Document Registry address, DID resolver registry service ID and/or address, etc. Further the transaction notification message 648 can be transformed into a DID resolver transaction to store the DID and DID Document Registry address to the corresponding registry (e.g., a DID resolver registry) indicated by the target DID resolver registry service ID and/or address. Alternatively, the L-RMS 604 can directly generate the DID resolver transaction which can include the DID resolver transaction notification message 648, e.g., the DID, DID Document Registry address, DID resolver registry service ID/address, etc.

At 650 the L-RMS 604 sends the DID resolver transaction which includes the DID resolver transaction notification message to the PDL node 606 and at 652 the PDL node 606 propagates the received DID resolver transaction through the system 600. At 654 the PDL node 608 (e.g., a PDL Node-2) receives the DID resolver transaction from the target PDL network as the result of transaction propagation 652.

Accordingly, the DID resolver transaction is validated and is successfully stored to the ledger, e.g., as a result of PDL consensus process in a ledger related to the registry service associated to the DID resolver (transaction) based on the target registry service type information. Further, at 656 the PDL node 608 forwards the DID resolver transaction to the registry service (e.g., the DID R/R service 614) based on the target Registry service information. The DID R/R service 614 transforms the transaction into a message to recover the message, e.g., a DID resolver registry transaction as a DID resolver transaction notification message. Alternatively, the PDL node 608 transforms the transaction into a message and sends the DID resolver transaction as a DID resolver transaction notification message to the DID R/R service 614.

At 658 the DID R/R service 614 may store the DID resolver transaction/information received as part of the DID resolver transaction notification message (or vice versa) in a local storage, off-chain, and/or as part of a ledger. At 660 the DID R/R service 614 sends to the L-RMS 604 an acknowledgement message 660 which can include L-RMS ID, DID, DID resolver ID/address, and a result indication, e.g., an indication of a success or a failure of the DID document storage request 618. Further, 644, 646 may be performed as described previously after performance of 648-660, e.g., 648-660 may be performed as an alternative to 640a, 640b.

The following describes some implementation details and/or alternative or additional implementations regarding the system 600. In implementations, the end client 602 as part of requesting service from a service provider may provide a DID resolver ID and/or address to enable the service provider to request the DID resolver for respective authentication of the end-device.

In implementations, for a failure case with reference to 626, 628, the L-RMS 604 can send to the end client 602 a DID document storage response message which can include a failure indication with a cause value, e.g., such as a violation code, an authorization failure, and authentication failure, etc.

In implementations, adaptations can be made to enable a DID controller to perform DID document storage for a DID holder and/or subject, e.g., the end client 602. For instance, the various actions discussed with reference to the system 600 can be applied with an additional adaptation that step 1, 622-638, and 642 can also include source Identity corresponding to the DID holder (e.g., subject) whose DID is being controlled by the DID controller. Further, access role information specific to the DID controller can be used in the storage procedures shown the system 600.

In implementations, adaptations can be made for the update of DID and DID documents, e.g., based on a request for a DID holder and/or DID controller. For instance, at 618 the end client 602 can send to the L-RMS 604 a DID document update request which can include Source Identity (e.g., a PDL user ID), Registration ID, service type information (e.g., to indicate a DID service), access role (e.g., indicated as ID/DID holder, which can be the subject and/or end-user; for a DID controller, access role can be indicated as “DID controller”), authorization information (e.g., a code and/or token received as authorization information during a successful registration), DID document(s), etc.

As an alternative or additional implementation, the end client 602 can send to the L-RMS 604 a DID document storage request which can include Source Identity (e.g., a PDL user ID), Registration ID, service type information (e.g., to indicate a DID service), access role (e.g., indicated as ID/DID holder, which can be the subject and/or end-user), authorization information (e.g., a code and/or token received as authorization information during a successful registration), the DID document(s) and the request type set as a DID document(s) update indication.
620-626: Same as described above.
628, 630: A DID document registry notification message (e.g., along with a related transaction) can include the request type set as “DID document(s) update indication” (e.g., instead of create/store indication) in addition to the other information elements.
632-638: Same as described above.
640a: The DID registry may send to the DID R/R service 614 a notification message (e.g., a DID resolver notification message) which can include DID, the request type set as “DID document(s) update indication”*, and DID Document Registry ID and/or address.
640b: The DID R/R service 614 can update the DID related DID Document Registry ID and/or address. Further the DID R/R service 614 can send to the DID Document registry service a DID resolver acknowledgement (Ack) message which can include DID and a success indication.

Step 648-656: Same as described above.

In implementations, adaptations can be made for deletion/revocation of DID and DID Documents, such as based on request from the DID holder, DID controller, Ledger-registration management service in the PDL platform, etc. In such implementations:

At 618 the end client 602 can send to the L-RMS 604 a DID document delete/revoke request which can include Source Identity (e.g., a PDL user ID), Registration ID, service type information (e.g., indicating a DID service), access role (e.g., indicated as ID and/or DID holder, which can be the subject and/or end-user; in implementations of a DID controller, can be indicated as “DID controller”), authorization information (e.g., a code or token received as authorization information during a successful registration), DID document(s), etc.

In an alternative or additional implementation, The end client 602 can send to the L-RMS 604 a DID document storage request which can include Source Identity (e.g., a PDL user ID), Registration ID, service type information (e.g., indicating a DID service), access role (e.g., indicated as ID and/or DID holder, which can be the subject/end-user), authorization information (e.g., a code or token received as authorization information during a successful registration), the DID document(s), and a request type set as DID document(s) delete/revoke indication.
620-626: Same as described above.
628, 630: A DID document registry notification message (as well as the related transaction) can include the request type set as “the DID document(s) delete/revoke indication” (e.g., instead of create/store indication) in addition to the other information elements.
632-638: Same as described above.
640a: The DID registry may send to the DID R/R service 614 a notification message (e.g., a DID resolver notification message) which can include DID, the request type set as “DID document(s) delete/revoke indication”*, and DID Document Registry ID/address.
640b: The DID R/R service 614 deletes and/or revokes the DID related DID Document Registry ID/address. Further the DID R/R service 614 sends to the RS-DID DR 612 a DID resolver acknowledgement (Ack) message which can include DID and a success indication.
648-646: Same as described above.

In implementations, smart contracts can be used by the registry services described in the different implementations to keep track of lifetime expirations and linking of DID related entries.

Implementations described herein provide ways to manage VC (e.g., store, update, delete/revoke), such as in a PDL platform, where a VC can represent a set of one or more claims made by an issuer. A VC, for example, is a tamper-evident credential that has authorship that can be cryptographically verified. A VC Issuer is a role an entity can perform by asserting claims about one or more subjects, creating a verifiable credential from these claims, and transmitting the verifiable credential to a holder, e.g., DID holder. A VC can be stored in a ledger over a PDL platform on request from a DID holder, DID controller, and/or VC Issuer, respectively. Accordingly, secure processes are provided for a requestor DID holder, DID controller, and/or VC Issuer:

Authentication of the requestor as identified by its DID and registration ID if it a DID holder, else by DID, source ID (ID of the DID holder and ID of DID controller) and registration ID (of the DID Controller) if the requestor is a DID controller, else if by DID (of the DID holder), source ID (of the VC Issuer) and registration ID (of the VC Issuer) if the requestor is a VC Issuer.

Proofing by the VC Issuer that the claimed attributes belong to the holder.

Revocation of a holder's attributes by the VC Issuer.

Further, the management of VC can include operations such as:
1. Storage of VC (e.g., on request from the DID holder, DID controller, and/or VC Issuer)
2. Update of VC (e.g., on request from the DID holder, DID controller, and/or VC Issuer)
3. Delete/Revoke VC (e.g., on request from the DID holder, DID controller, and/or VC Issuer)

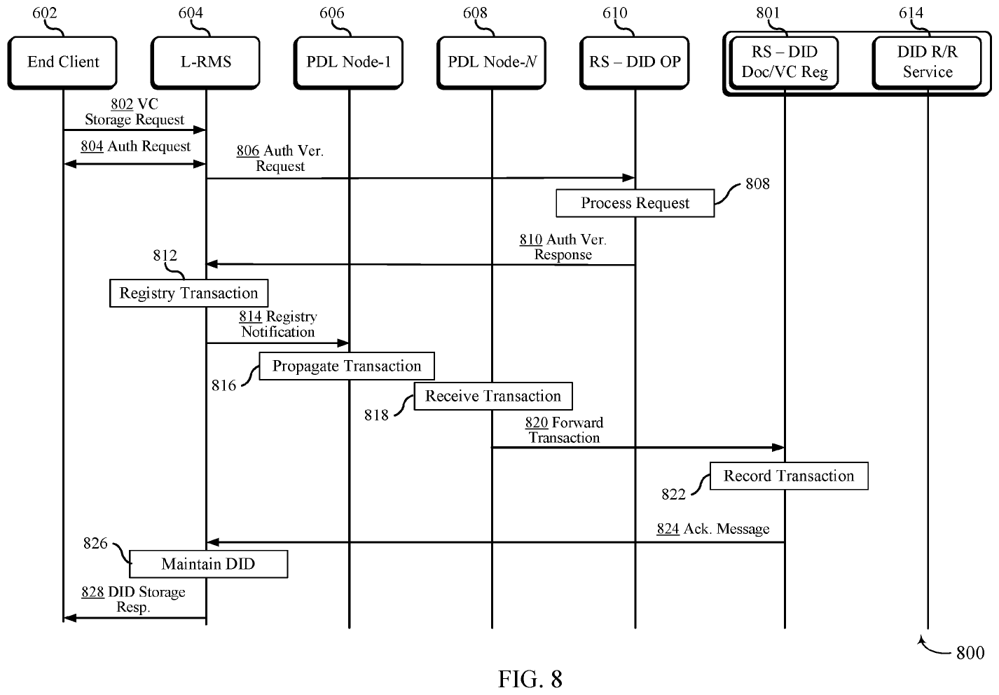

FIG. 8 illustrates a system 800 that supports digital identity management in accordance with aspects of the present disclosure. The system 800, for instance, represents an implementation for VC storage management and utilizes various features of the system 600 described above. In this particular example the system 800 includes a registry service DID document/VC registry (RS-DID Doc/VC Reg) 801 which can provide registry services for DID documents and VC.

At 802 the end client 602 (e.g., related to a VC Issuer) can send to the L-RMS 604 a VC storage request 802 which can include a Source Identity (e.g., a PDL user ID for the VC Issuer), Registration ID (of the VC Issuer), service type information (e.g., indicating a DID service), access role (e.g., indicated as VC Issuer, which can be the subject and/or end-user), authorization information (e.g., a code and/or token received as authorization information during a successful registration), DID, VCs, and a request type, e.g., set as create/store. In implementations, if a secure connection exists, the end client 602 can send 802 directly. Else the end client 602 and the L-RMS 604 can perform mutual authentication and set up a secure connection before sending the VC storage request 802.

Alternatively, the end client 602 (e.g., a VC Issuer) can send at 802 to the L-RMS 604 information except for registration ID, access role, DID, VCs and the authorization code. The L-RMS 604 can then at 804 request this information by sending an authorization request message with source ID and the end client 602 can respond at 804 with an authorization response message with Registration ID, access role, DID, VCs, and authorization information.

At 806 the L-RMS 604 sends an authorization verification request message 806 to the RS-DID OP 610 (e.g., as related to the DID Operation(al) participants and/or Identity and Trust management framework/platform participants) based on the local configuration and policies. The authorization verification request message 806 can include Registration ID, Source ID, Access role and authorization information, e.g., code and/or token for authorization.

At 808 the RS-DID OP 610 verifies the authorization information (e.g., authorization code and/or token) related to the Registration ID and the access role by querying the respective ledger and/or chain (e.g., for a related transaction history and/or records) and/or by checking an offline and/or local storage to check if the authorization information and registration ID matches with a record related to a registered participant. The RS-DID OP 610 also checks if the access role of the participant is correct based on the records.

At 810 if the verification of the registration ID, access role and authorization information are successful, then the RS-DID OP 610 sends an authorization verification response message 810 to the L-RMS 604, which can include the registration ID (e.g., of the VC Issuer), source ID, and a result of the authorization verification request message 806, e.g., a success or a failure.

If the verification of the registration ID, access role and authorization information do not match with a record, and/or if the registered access role is different from the one received with 806, RS-DID OP 610 can send to the L-RMS 604 the authorization verification request message 810 which can include the registration ID, source ID, and result as “failure.”

At 812 if the L-RMS 604 determines that the authorization verification is successful (e.g., based on 810), the L-RMS 604 generates a VC registry notification message 814 which can include the target Registry service type and/or ID, Create Indication*, L-RMS ID, Source Identity, Service type information (DID service), Registration ID, authorized access role, Authorization code, Lifetime, DID, VC(s), etc. Further the VC registry notification message 814 can be transformed into a VC transaction to store VCs along with the respective DID to the corresponding registry (e.g., “VC registry”) indicated by the target Registry service type and/or ID.

In an alternative or additional implementation, the L-RMS 604 can directly generate the VC transaction which can include the VC registry notification message 814, e.g., target Registry service type and/or ID, request type set as Create/store Indication*, L-RMS ID, Source Identity, Service type information (DID service), Registration ID, authorized access role, Authorization code, Lifetime, DID, and DID Document(s). Alternatively, for a failure is indicated at 810, then the system 800 can proceed to 828 where a failure case is indicated.

The L-RMS 604 then sends the VC transaction (which includes the VC registry notification message 814) to the PDL node 606. At 816 the PDL node 606 propagates the received VC transaction through the system 800. At 818 the PDL node 608 (e.g., any PDL Node-2) receives the VC transaction from the target PDL network as the result of transaction propagation.

After the VC transaction is validated, it is stored to a ledger, e.g., as a result of PDL consensus process in a ledger related to the registry service associated to the VC transaction based on target registry service type information. Further, at 820 the PDL node 608 forwards the VC transaction to the RS-DID Doc/VC Reg 801 (e.g., VC registry) based on the target Registry service information. The RS-DID Doc/VC Reg 801 transforms the transaction into a message to recover the message (e.g., VC registry transaction as a VC registry notification message). In an alternative or additional implementation, the PDL node 608 transforms the VC transaction (which includes the VC registry notification message 814) into a message and sends the VC transaction as a VC registry notification message to the RS-DID Doc/VC Reg 801.

At 822 the RS-DID Doc/VC Reg 801 may store the VC transaction and/or information (e.g., DID and VC) received as part of 820 (or vice versa) in a local storage, off-chain, and/or as part of a ledger. At 824 the RS-DID Doc/VC Reg 801 sends to the L-RMS 604 an acknowledgement message 824 which can include the L-RMS ID (e.g., received at 820 as part of the transaction and/or message related to the VC registry notification), Source Identity, Registry service type/ID, VC Registry address, and a result of the storage request, e.g., success or failure.

At 826 the L-RMS 604 maintains the DID and the relative VC registry ID/address information in a local storage or in off-chain. At 828 the L-RMS 604 sends to the end client 602 a VC storage response message, which can include the DID and a result of the storage request 802, e.g., success or failure. In an alternative implementation, for the failure case occurring at 810, 812, the L-RMS 604 can send to the end client 602 a VC storage response message, which can include the failure indication with a cause value, e.g., such as violation code, authorization failure, authentication failure, etc.

Implementations can include adaptations for a DID controller performing VC storage for an DID holder and/or subject. For instance, in the system 800, 802-828 can be applied with an additional adaptation that 802 and 806-826 can also include source Identity corresponding to the DID holder (e.g., subject) whose DID is being controlled by the DID controller. Further, the access role information specific to the DID controller can be used in the storage procedure shown in the system 800.

Implementations can include adaptations for update of VCs (e.g., on request from the DID holder or DID controller): For instance, at 802 the end client 602 can send to the L-RMS 604 a VC update request which can include Source Identity (e.g., a PDL user ID), Registration ID, service type information (e.g., indicating a DID service), access role (e.g., indicated as “ID/DID holder”, which can be the subject and/or end-user or in a scenario of a DID controller, indicated as “DID controller”), authorization information (e.g., a code and/or token received as authorization information during a successful registration), DID, VC(s), etc.

In an alternative or additional implementation, the end client 602 can send to the L-RMS 604 a VC storage request which can include Source Identity (e.g., a PDL user ID), Registration ID, service type information (e.g., indicating a DID service), access role (e.g., indicated as “ID/DID holder,” which can be the subject and/or end-user or in a scenario of a DID controller, indicating “DID controller”), authorization information (e.g., a code and/or token received as authorization information during a successful registration), DID, the VC(s) and the request type set as VC(s) update indication.
804-810: Same as described above.
812, 814: A VC registry notification message (as well as the related transaction) can include “the request type set as VC(s) update indication” (e.g., instead of create/store indication) in addition to other information elements.
816-828: Same as described above.

Implementations can include adaptations for deletion and revocation of VC (e.g., on request from the DID holder, DID controller, Ledger-registration management service in a PDL platform, etc.: For instance, at 802 the end client 602 can send to the L-RMS 604 a VC delete/revoke request which can include Source Identity (e.g., a PDL user ID), Registration ID, service type information (e.g., indicating a DID service), access role (e.g., indicated as “ID/DID holder,” which can be the subject/end-user, and/or in a scenario of a DID controller, indicated as “DID controller”), authorization information (e.g., a code and/or token received as authorization information during a successful registration), DID, VC(s), etc.

In an alternative or additional implementation, the end client 602 can send to the L-RMS 604 a VC storage request which can include Source Identity (e.g., a PDL user ID), Registration ID, service type information (e.g., indicating a DID service), access role (e.g., indicated as “ID/DID holder,” which can be the subject/end-user, and/or in a scenario of a DID controller, indicated as “DID controller”), authorization information (e.g., a code and/or token received as authorization information during a successful registration), DID, VC(s), and the request type set as VC delete/revoke indication.
804-810: Same as described above.
812, 814: The VC registry notification message (as well as the related transaction) can include the request type set as VC delete/revoke indication (e.g., instead of create/store indication) in addition to other information elements.
816-828: Same as described above.

In implementations smart contracts can be used by the registry services described in the different implementations to keep track of lifetime expirations and linking of DID-related entries, etc.

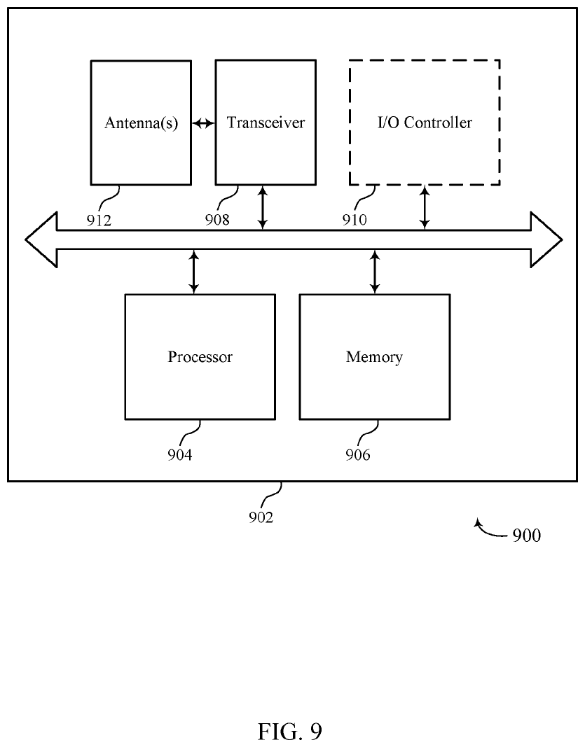

FIG. 9 illustrates an example of a block diagram 900 of a device 902 (e.g., an apparatus) that supports digital identity management in accordance with aspects of the present disclosure. The device 902 may be an example of a network entity 102 as described herein. The device 902 may support wireless communication with one or more network entities 102, UEs 104, or any combination thereof. The device 902 may include components for bi-directional communications including components for transmitting and receiving communications, such as a processor 904, a memory 906, a transceiver 908, and an I/O controller 910. These components may be in electronic communication or otherwise coupled (e.g., operatively, communicatively, functionally, electronically, electrically) via one or more interfaces (e.g., buses).

The processor 904, the memory 906, the transceiver 908, or various combinations thereof or various components thereof may be examples of means for performing various aspects of the present disclosure as described herein. For example, the processor 904, the memory 906, the transceiver 908, or various combinations or components thereof may support a method for performing one or more of the operations described herein.

In some implementations, the processor 904, the memory 906, the transceiver 908, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 904 and the memory 906 coupled with the processor 904 may be configured to perform one or more of the functions described herein (e.g., executing, by the processor 904, instructions stored in the memory 906). In the context of network entity 102, for example, the transceiver 908 and the processor 904 coupled to the transceiver 908 are configured to cause the network entity 102 to perform the various described operations and/or combinations thereof.

For example, the processor 904 and/or the transceiver 908 may support wireless communication at the device 902 in accordance with examples as disclosed herein. For instance, the processor 904 and/or the transceiver 908 may be configured as or otherwise support a means to receive a storage request including a storage object and one or more of a source identifier, a registration identifier, service type information, access role, an authorization information, a decentralized identifier, or a request type; transmit an authorization verification request for the storage request; receive an authorization verification response based at least in part on the authorization verification request; transmit, based at least in part on the authorization verification response, a registry notification including the storage object and one or more of registry service information, the request type, the source identifier, the service type information, the registration identifier, or authorization information; receive, based at least in part on the registry notification, an acknowledgement message; and transmit a storage response including an indication of a result of the storage request.

Further, in some implementations, the storage object includes one or more of a decentralized identifier, a decentralized identifier document, or a verifiable credential; the apparatus is implemented as part of a ledger registration management service, and where the processor is configured to: receive the storage request from one or more of an end-point device or an application; transmit the authorization verification request to and receive the authorization verification response from a registry service; transmit the registry notification to one or more of a permissioned distributed ledger node or a permissioned distributed ledger network; receive the acknowledgement message from a registry service; and transmit the storage response to one or more of the end-point device or the application; the registry notification further includes one or more of an identifier for the ledger registration management service, an authorized access role for the storage request, or a lifetime for the storage object; the registry service includes a decentralized identifier operation participant registry service; the processor is further configured to transmit a registry notification transaction to the permissioned distributed ledger node, where the registry notification transaction includes one or more of a registry service type, a registry service identifier, a ledger registration management service identifier, the source identifier, the service type information, the registration identifier, an authorized access role, the authorization information, a lifetime for the storage object, a decentralized identifier, a decentralized identifier document, a verifiable credential, or request type information.

Further, in some implementations, the lifetime includes a lifetime for at least one of one or more decentralized identifier documents or one or more verifiable credentials; the storage request is associated with one or more of a decentralized identifier or a decentralized identifier document, and the storage response further includes one or more of a decentralized identifier resolver identifier, a decentralized identifier document registry address, a decentralized identifier document registry identifier, or a decentralized identifier resolver address; the request type includes one or more of a create indication, an update indication, or a delete indication; the authorization verification request includes one or more of the registration identifier, the source identifier, an access role for the storage request, or authorization information; the authorization information includes one or more of a code or a token; the authorization verification response includes one or more of the registration identifier, the source identifier, or a result indication for the authorization verification request; the processor is further configured to perform message to transaction adaptation to transform the registry notification into a registry notification transaction; the registry notification is related to one or more of a decentralized identifier document or a verifiable credential; the access role indicates whether the storage request is initiated by one or more of an identity holder, an identity controller, a decentralized identifier holder, a decentralized identifier controller, or a verifiable credential issuer; the indication of the result of the storage request includes an indication of a success of the storage request; the indication of the result of the storage request includes an indication of a failure of the storage request.

In a further example, the processor 904 and/or the transceiver 908 may support wireless communication at the device 902 in accordance with examples as disclosed herein. The processor 904 and/or the transceiver 908, for instance, may be configured as or otherwise support a means to receive an authorization verification request for a storage request for a storage object, the authorization verification request including one or more of a registration identifier, a source identifier, an access role associated with the storage request, or an authorization code; process the authorization verification request to determine whether the authorization verification request is valid; and transmit an authorization verification response including an indication of a result of the authorization verification request and one or more of the registration identifier or the source identifier.

Further, in some implementations, the storage object includes one or more of a decentralized identifier, a decentralized identifier document, or a verifiable credential; the apparatus is implemented as part of a registry service, and wherein the processor is configured to: receive the authorization verification request from a ledger registration management service; and transmit the authorization verification response to the ledger registration management service; the indication of the result of the authorization verification request includes one of an indication of a success of the authorization verification request or a failure of the authorization verification request.

In a further example, the processor 904 and/or the transceiver 908 may support wireless communication at the device 902 in accordance with examples as disclosed herein. The processor 904 and/or the transceiver 908, for instance, may be configured as or otherwise support a means to receive a registry notification transaction, where the registry notification transaction includes a storage object and one or more of a registry service type, a registry service identifier, a ledger registration management service identifier, a source identifier, a service type information, a registration identifier, an authorized access role, authorization information, a lifetime for a storage object, a decentralized identifier, a decentralized identifier document, a verifiable credential, or request type information; record the registry notification transaction; and transmit an acknowledgement message including an indication of a result of the registry notification transaction and one or more of a registry service type, a registry service identifier, a storage object registry address, a storage object resolver identifier, or a storage object resolver address.

Further, in some implementations, the storage object includes one or more of a decentralized identifier, a decentralized identifier document, or a verifiable credential; the apparatus is implemented as part of a storage object registry service, and wherein the processor is configured to: receive the registry notification transaction from a permissioned distributed ledger node; and transmit the acknowledgement message to a ledger registration management service; the indication of the result of the registry notification transaction includes one of an indication of a success of the registry notification transaction or a failure of the registry notification transaction.

In a further example, the processor 904 and/or the transceiver 908 may support wireless communication at the device 902 in accordance with examples as disclosed herein. The processor 904 and/or the transceiver 908, for instance, may be configured as or otherwise support a means to transmit a decentralized identifier resolver transaction notification including a decentralized identifier and one or more of a request type, a decentralized identifier registry address, a decentralized identifier resolver identifier, or a decentralized identifier resolver address; and receive an acknowledgement message including a result of the decentralized identifier resolver transaction notification and one or more of a ledger registration management service identifier, the decentralized identifier, the decentralized identifier resolver identifier, a decentralized identifier document registry address, a decentralized identifier document registry identifier, or the decentralized identifier resolver address.

Further, in some implementations, the result of the decentralized identifier resolver transaction notification includes one of an indication of a success of the decentralized identifier resolver transaction notification or a failure of the decentralized identifier resolver transaction notification.

In a further example, the processor 904 and/or the transceiver 908 may support wireless communication at the device 902 in accordance with examples as disclosed herein. The processor 904 and/or the transceiver 908, for instance, may be configured as or otherwise support a means to receive a decentralized identifier resolver transaction notification including a decentralized identifier and one or more of a decentralized identifier registry address, a decentralized identifier resolver identifier, or a decentralized identifier resolver address; store at least some information included in the decentralized identifier resolver transaction notification; and transmit an acknowledgement message including a result of the decentralized identifier resolver transaction notification and one or more of a ledger registration management service identifier, the decentralized identifier, the decentralized identifier resolver identifier, a decentralized identifier document registry address, a decentralized identifier document registry identifier, or the decentralized identifier resolver address.

Further, in some implementations, the result of the decentralized identifier resolver transaction notification includes one of an indication of a success of the decentralized identifier resolver transaction notification or a failure of the decentralized identifier resolver transaction notification.

The processor 904 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 904 may be configured to operate a memory array using a memory controller. In some other implementations, a memory controller may be integrated into the processor 904. The processor 904 may be configured to execute computer-readable instructions stored in a memory (e.g., the memory 906) to cause the device 902 to perform various functions of the present disclosure.

The memory 906 may include random access memory (RAM) and read-only memory (ROM). The memory 906 may store computer-readable, computer-executable code including instructions that, when executed by the processor 904 cause the device 902 to perform various functions described herein. The code may be stored in a non-transitory computer-readable medium such as system memory or another type of memory. In some implementations, the code may not be directly executable by the processor 904 but may cause a computer (e.g., when compiled and executed) to perform functions described herein. In some implementations, the memory 906 may include, among other things, a basic I/O system (BIOS) which may control basic hardware or software operation such as the interaction with peripheral components or devices.

The I/O controller 910 may manage input and output signals for the device 902. The I/O controller 910 may also manage peripherals not integrated into the device M02. In some implementations, the I/O controller 910 may represent a physical connection or port to an external peripheral. In some implementations, the I/O controller 910 may utilize an operating system such as iOS®, ANDROID®, MS-DOS®, MS-WINDOWS®, OS/2®, UNIX®, LINUX®, or another known operating system. In some implementations, the I/O controller 910 may be implemented as part of a processor, such as the processor M06. In some implementations, a user may interact with the device 902 via the I/O controller 910 or via hardware components controlled by the I/O controller 910.

In some implementations, the device 902 may include a single antenna 912. However, in some other implementations, the device 902 may have more than one antenna 912 (e.g., multiple antennas), including multiple antenna panels or antenna arrays, which may be capable of concurrently transmitting or receiving multiple wireless transmissions. The transceiver 908 may communicate bi-directionally, via the one or more antennas 912, wired, or wireless links as described herein. For example, the transceiver 908 may represent a wireless transceiver and may communicate bi-directionally with another wireless transceiver. The transceiver 908 may also include a modem to modulate the packets, to provide the modulated packets to one or more antennas 912 for transmission, and to demodulate packets received from the one or more antennas 912.

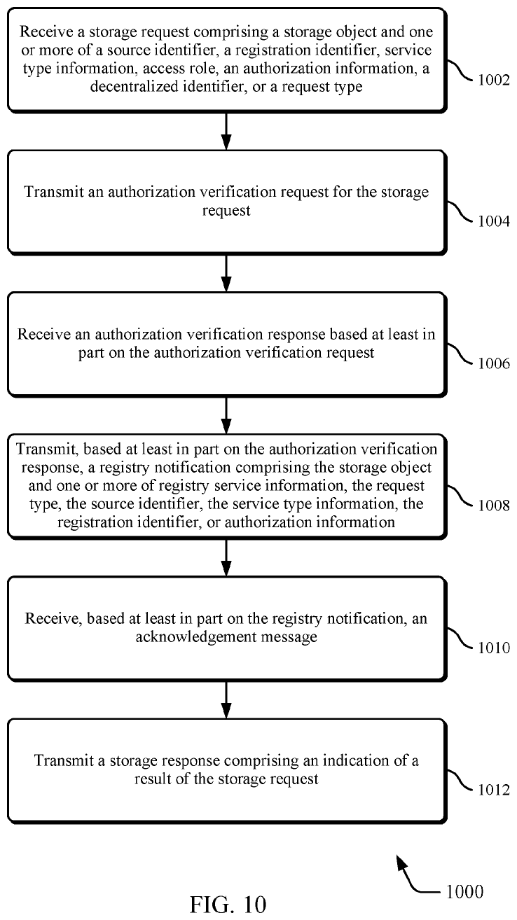

FIG. 10 illustrates a flowchart of a method 1000 that supports digital identity management in accordance with aspects of the present disclosure. The operations of the method 1000 may be implemented by a device or its components as described herein. For example, the operations of the method 1000 may be performed by a network entity 102 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1002, the method may include receiving a storage request comprising a storage object and one or more of a source identifier, a registration identifier, service type information, access role, an authorization information, a decentralized identifier, or a request type. The operations of 1002 may be performed in accordance with examples as described herein. In some implementations, aspects of the operations of 1002 may be performed by a device as described with reference to FIG. 1.

At 1004, the method may include transmitting an authorization verification request for the storage request. The operations of 1004 may be performed in accordance with examples as described herein. In some implementations, aspects of the operations of 1004 may be performed by a device as described with reference to FIG. 1.

At 1006, the method may include receiving an authorization verification response based at least in part on the authorization verification request. The operations of 1006 may be performed in accordance with examples as described herein. In some implementations, aspects of the operations of 1006 may be performed by a device as described with reference to FIG. 1.

At 1008, the method may include transmitting, based at least in part on the authorization verification response, a registry notification comprising the storage object and one or more of registry service information, the request type, the source identifier, the service type information, the registration identifier, or authorization information. The operations of 1008 may be performed in accordance with examples as described herein. In some implementations, aspects of the operations of 1008 may be performed by a device as described with reference to FIG. 1.

At 1010, the method may include receiving, based at least in part on the registry notification, an acknowledgement message. The operations of 1010 may be performed in accordance with examples as described herein. In some implementations, aspects of the operations of 1010 may be performed by a device as described with reference to FIG. 1.

At 1012, the method may include transmitting a storage response comprising an indication of a result of the storage request. The operations of 1012 may be performed in accordance with examples as described herein. In some implementations, aspects of the operations of 1012 may be performed by a device as described with reference to FIG. 1.

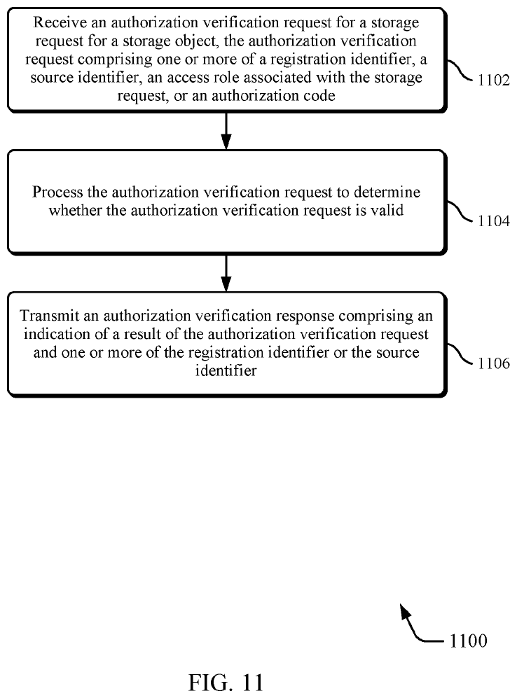

FIG. 11 illustrates a flowchart of a method 1100 that supports digital identity management in accordance with aspects of the present disclosure. The operations of the method 1100 may be implemented by a device or its components as described herein. For example, the operations of the method 1100 may be performed by a network entity 102 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1102, the method may include receiving an authorization verification request for a storage request for a storage object, the authorization verification request comprising one or more of a registration identifier, a source identifier, an access role associated with the storage request, or an authorization code. The operations of 1102 may be performed in accordance with examples as described herein. In some implementations, aspects of the operations of 1102 may be performed by a device as described with reference to FIG. 1.

At 1104, the method may include processing the authorization verification request to determine whether the authorization verification request is valid. The operations of 1104 may be performed in accordance with examples as described herein. In some implementations, aspects of the operations of 1104 may be performed by a device as described with reference to FIG. 1.

At 1106, the method may include transmitting an authorization verification response comprising an indication of a result of the authorization verification request and one or more of the registration identifier or the source identifier. The operations of 1106 may be performed in accordance with examples as described herein. In some implementations, aspects of the operations of 1106 may be performed by a device as described with reference to FIG. 1.

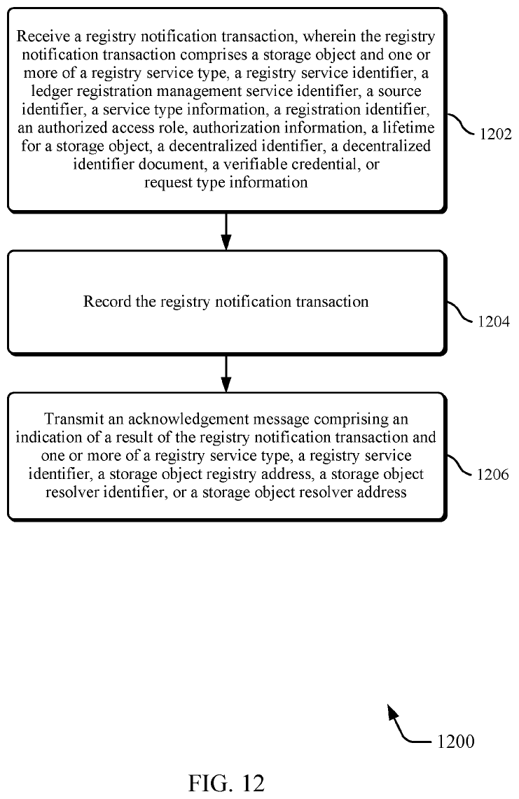

FIG. 12 illustrates a flowchart of a method 1200 that supports digital identity management in accordance with aspects of the present disclosure. The operations of the method 1200 may be implemented by a device or its components as described herein. For example, the operations of the method 1200 may be performed by a network entity 102 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1202, the method may include receiving a registry notification transaction, wherein the registry notification transaction comprises a storage object and one or more of a registry service type, a registry service identifier, a ledger registration management service identifier, a source identifier, a service type information, a registration identifier, an authorized access role, authorization information, a lifetime for a storage object, a decentralized identifier, a decentralized identifier document, a verifiable credential, or request type information. The operations of 1202 may be performed in accordance with examples as described herein. In some implementations, aspects of the operations of 1202 may be performed by a device as described with reference to FIG. 1.

At 1204, the method may include recording the registry notification transaction. The operations of 1204 may be performed in accordance with examples as described herein. In some implementations, aspects of the operations of 1204 may be performed by a device as described with reference to FIG. 1.

At 1206, the method may include transmitting an acknowledgement message comprising an indication of a result of the registry notification transaction and one or more of a registry service type, a registry service identifier, a storage object registry address, a storage object resolver identifier, or a storage object resolver address. The operations of 1206 may be performed in accordance with examples as described herein. In some implementations, aspects of the operations of 1206 may be performed by a device as described with reference to FIG. 1.

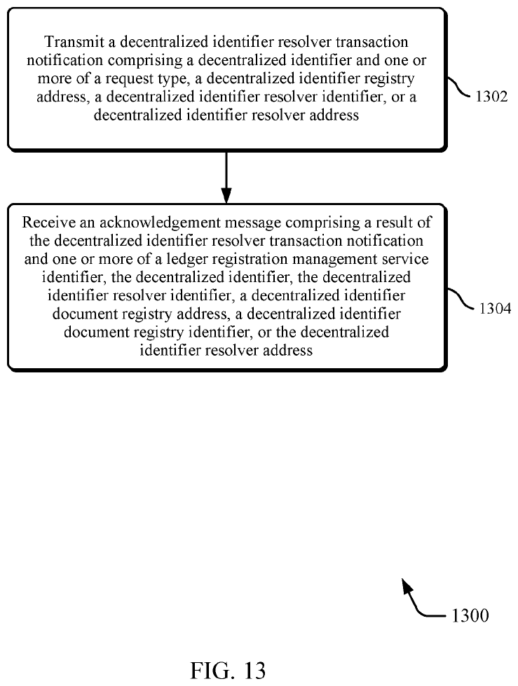

FIG. 13 illustrates a flowchart of a method 1300 that supports digital identity management in accordance with aspects of the present disclosure. The operations of the method 1300 may be implemented by a device or its components as described herein. For example, the operations of the method 1300 may be performed by a network entity 102 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1302, the method may include transmitting a decentralized identifier resolver transaction notification comprising a decentralized identifier and one or more of a request type, a decentralized identifier registry address, a decentralized identifier resolver identifier, or a decentralized identifier resolver address. The operations of 1302 may be performed in accordance with examples as described herein. In some implementations, aspects of the operations of 1302 may be performed by a device as described with reference to FIG. 1.

At 1304, the method may include receiving an acknowledgement message comprising a result of the decentralized identifier resolver transaction notification and one or more of a ledger registration management service identifier, the decentralized identifier, the decentralized identifier resolver identifier, a decentralized identifier document registry address, a decentralized identifier document registry identifier, or the decentralized identifier resolver address. The operations of 1304 may be performed in accordance with examples as described herein. In some implementations, aspects of the operations of 1304 may be performed by a device as described with reference to FIG. 1.

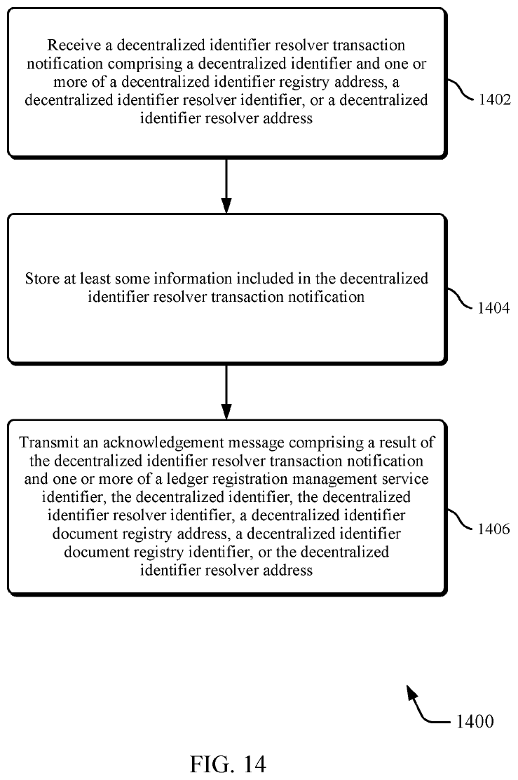

FIG. 14 illustrates a flowchart of a method 1400 that supports digital identity management in accordance with aspects of the present disclosure. The operations of the method 1400 may be implemented by a device or its components as described herein. For example, the operations of the method 1400 may be performed by a network entity 102 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1402, the method may include receiving a decentralized identifier resolver transaction notification comprising a decentralized identifier and one or more of a decentralized identifier registry address, a decentralized identifier resolver identifier, or a decentralized identifier resolver address. The operations of 1402 may be performed in accordance with examples as described herein. In some implementations, aspects of the operations of 1402 may be performed by a device as described with reference to FIG. 1.

At 1404, the method may include storing at least some information included in the decentralized identifier resolver transaction notification. The operations of 1404 may be performed in accordance with examples as described herein. In some implementations, aspects of the operations of 1404 may be performed by a device as described with reference to FIG. 1.

At 1406, the method may include transmitting an acknowledgement message comprising a result of the decentralized identifier resolver transaction notification and one or more of a ledger registration management service identifier, the decentralized identifier, the decentralized identifier resolver identifier, a decentralized identifier document registry address, a decentralized identifier document registry identifier, or the decentralized identifier resolver address, and one or more of a ledger registration management service identifier, the decentralized identifier, the decentralized identifier resolver identifier, a decentralized identifier document registry address, a decentralized identifier document registry identifier, or the decentralized identifier resolver address. The operations of 1406 may be performed in accordance with examples as described herein. In some implementations, aspects of the operations of 1406 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity comprising:
at least one memory; and
at least one processor coupled with the at least one memory and operable to cause the network entity to:
receive a storage request comprising a storage object and one or more of a source identifier, a registration identifier, a service type information, an access role, an authorization information, a decentralized identifier, or a request type;
transmit an authorization verification request in response to the storage request;
receive an authorization verification response in response to the authorization verification request;
transmit, based at least in part on the authorization verification response, a registry notification comprising the storage object and one or more of registry service information, the request type, the source identifier, the service type information, the registration identifier, or authorization information;
receive, based at least in part on the registry notification, an acknowledgement message; and
transmit a storage response comprising an indication of a result of the storage request.

2. The network entity of claim 1, wherein the storage object comprises one or more of a decentralized identifier, a decentralized identifier document, or a verifiable credential.

3. The network entity of claim 1, wherein the network entity is implemented as part of a ledger registration management service, and wherein the at least one processor is operable to cause the network entity to:
receive the storage request from one or more of an end-point device or an application;
transmit the authorization verification request to a registry service;
receive the authorization verification response from the registry service;
transmit the registry notification to one or more of a permissioned distributed ledger node or a permissioned distributed ledger network;
receive the acknowledgement message from the registry service; and
transmit the storage response to one or more of the end-point device or the application.

4. The network entity of claim 3, wherein the registry notification further comprises one or more of an identifier for the ledger registration management service, an authorized access role for the storage request, or a lifetime for the storage object.

5. The network entity of claim 3, wherein the registry service comprises a decentralized identifier operation participant registry service.

6. The network entity of claim 3, wherein the at least one processor is operable to cause the network entity to transmit a registry notification transaction to the permissioned distributed ledger node, wherein the registry notification transaction comprises one or more of a registry service type, a registry service identifier, a ledger registration management service identifier, the source identifier, the service type information, the registration identifier, an authorized access role, the authorization information, a lifetime for the storage object, a decentralized identifier, a decentralized identifier document, a verifiable credential, or request type information.

7. The network entity of claim 6, wherein the lifetime comprises a lifetime for at least one of one or more decentralized identifier documents or one or more verifiable credentials.

8. The network entity of claim 1, wherein the storage request is associated with one or more of a decentralized identifier or a decentralized identifier document, and the storage response further comprises one or more of a decentralized identifier resolver identifier, a decentralized identifier document registry address, a decentralized identifier document registry identifier, or a decentralized identifier resolver address.

9. The network entity of claim 1, wherein the request type comprises one or more of a create indication, an update indication, or a delete indication.

10. The network entity of claim 1, wherein the authorization verification request comprises one or more of the registration identifier, the source identifier, an access role for the storage request, or authorization information.

11. The network entity of claim 10, wherein the authorization information comprises one or more of a code or a token.

12. The network entity of claim 1, wherein the authorization verification response comprises one or more of the registration identifier, the source identifier, or a result indication for the authorization verification request.

13. The network entity of claim 1, wherein the at least one processor is further operable to perform message to transaction adaptation to transform the registry notification into a registry notification transaction.

14. The network entity of claim 1, wherein the registry notification is related to one or more of a decentralized identifier document or a verifiable credential.

15. The network entity of claim 1, wherein the access role indicates whether the storage request is initiated by one or more of an identity holder, an identity controller, a decentralized identifier holder, a decentralized identifier controller, or a verifiable credential issuer.

16. The network entity of claim 1, wherein the indication of the result of the storage request comprises an indication of a success of the storage request.

17. The network entity of claim 1, wherein the indication of the result of the storage request comprises an indication of a failure of the storage request.

18. A network entity comprising:
at least one memory; and
at least one processor coupled with the at least one memory and operable to cause the network entity to:
receive an authorization verification request in response to a storage request for a storage object, the authorization verification request comprising one or more of a registration identifier, a source identifier, an access role associated with the storage request, or an authorization code;
process the authorization verification request to determine whether the authorization verification request is valid; and
transmit an authorization verification response comprising an indication of a result of the authorization verification request and one or more of the registration identifier or the source identifier.

19. A network entity comprising:
at least one memory; and
at least one processor coupled with the at least one memory and operable to cause the network entity to:
receive a registry notification transaction, wherein the registry notification transaction comprises a storage object and one or more of a registry service type, a registry service identifier, a ledger registration management service identifier, a source identifier, a service type information, a registration identifier, an authorized access role, authorization information, a lifetime for a storage object, a decentralized identifier, a decentralized identifier document, a verifiable credential, or request type information;
record the registry notification transaction; and
transmit an acknowledgement message comprising an indication of a result of the registry notification transaction and one or more of a registry service type, a registry service identifier, a storage object registry address, a storage object resolver identifier, or a storage object resolver address.

20. A network entity comprising:
at least one memory; and
at least one processor coupled with the at least one memory and operable to cause the network entity to:
transmit a decentralized identifier resolver transaction notification comprising a decentralized identifier and one or more of a request type, a decentralized identifier registry address, a decentralized identifier resolver identifier, or a decentralized identifier resolver address; and
receive an acknowledgement message comprising a result of the decentralized identifier resolver transaction notification and one or more of a ledger registration management service identifier, the decentralized identifier, the decentralized identifier resolver identifier, a decentralized identifier document registry address, a decentralized identifier document registry identifier, or the decentralized identifier resolver address.
